(19) United States
(12) Patent Application Publication
(10) Pub. No.: US 2026/0012005 A1
(43) Pub. Date: Jan. 8, 2026

(54) CIRCUIT ARRANGEMENT HAVING AN ELECTRIC DEVICE WITH A MAGNETIZABLE MAGNETIC CORE

(71) Applicant: Siemens Energy Global GmbH & Co. KG, München (DE)

(72) Inventor: Peter Hamberger, Kirchschlag bei Linz (AT)

(21) Appl. No.: 19/262,364

(22) Filed: Jul. 8, 2025

(30) Foreign Application Priority Data
Jul. 8, 2024 (DE) 10 2024 206 382.7

(51) Int. Cl. H02H 9/00; H01F 27/24; H01F 27/28

(52) U.S. Cl. CPC H02H 9/001; H01F 27/24; H01F 27/28

(57) ABSTRACT

A circuit arrangement contains an electric device having a magnetizable magnetic core and at least one winding which is configured for generating a magnetic flux in the magnetic core, and an auxiliary inductor which is electrically connected to the winding of the electric device and is configured for limiting an inrush current during switching-on of the electric device.

### CROSS-REFERENCE TO RELATED APPLICATION

This application claims the priority, under 35 U.S.C. § 119, of German Patent Application DE 10 2024 206 382.7, filed Jul. 8, 2024; the prior application is herewith incorporated by reference in its entirety.

### FIELD AND BACKGROUND OF THE INVENTION

The invention relates to a circuit arrangement containing an electric device having a magnetizable magnetic core and at least one winding which is configured for generating a magnetic flux in the magnetic core. Furthermore, the invention relates to a method for operating such a circuit arrangement.

In particular, the electric device can be a transformer. If one connects such an electric device to an electrical grid at an inopportune time (at a zero crossing of a voltage), then the magnetic core can be driven into saturation in a half wave of the mains voltage. This brings about a high increase of the magnetomotive force of the magnetic core, which is required for generating the magnetic flux, and a high inrush current is therefore brought about. In addition to that, the remanent magnetization of the magnetic core is disadvantageous if the inrush current surge increases again. Thus, very high current surges can be caused during switching-on of the electric device.

### SUMMARY OF THE INVENTION

The invention is based on the object of avoiding high current surges when switching on an electric device which contains a magnetizable magnetic core and at least one winding which is configured for generating a magnetic flux in the magnetic core.

The object is achieved according to the invention by a circuit arrangement having the features of the independent circuit arrangement claim and a method having the features of the independent method claim.

Advantageous refinements of the invention are the subject matter of the dependent claims.

A circuit arrangement according to the invention contains an electric device having a magnetizable magnetic core and at least one winding which is configured for generating a magnetic flux in the magnetic core, and an auxiliary inductor which is electrically connected to the winding of the electric device and is configured for limiting an inrush current during switching-on of the electric device.

The auxiliary inductor is dimensioned such that the inrush current of the electric device is limited to a specified maximum value even if the magnetic core of the electric device is completely saturated. The auxiliary inductor therefore enables a soft switching-on of the electric device even in the case of saturation of the magnetic core.

One embodiment of the circuit arrangement according to the invention contains a compensating device which is configured for suppressing a DC magnetic flux component in the magnetic core.

Particularly in the case of an electrical transformer that is used in energy transmission grids and distribution grids, a direct current may undesirably be fed into the windings of the transformer. Even power electronics components in the electrical grid, for example the drive circuit of electric drives, inverters for flexible alternating-current transmission systems, stray currents of train systems operated using direct current or high-voltage DC transmission can bring about direct currents in the transformer.

A direct current component in the windings of the transformer results in a DC magnetic flux component in the magnetic core of the transformer and the DC magnetic flux component is superposed on an AC magnetic flux. This causes an unsymmetrical magnetization of the magnetic core, which brings with it a series of disadvantages. Even a small direct current of a few amperes leads to a saturation of the magnetic core with magnetic flux. This is connected with a significant increase in the losses in the magnetic core. Furthermore, there is an increase in noise emissions during operation of the transformer, which is perceived as particularly troublesome in particular if the transformer is operated in the vicinity of a residential area.

The compensating device counteracts a DC magnetic flux component in the magnetic core and thus an asymmetrical magnetization of the magnetic core. For example, the compensating device has a compensating winding for generating a magnetic flux in the magnetic core, the effect of which opposes a DC flux component. Suitable compensating devices of this kind are known for example from European patent applications EP 3 783 630 A1 and EP 3 786 987 A1 and are therefore not described in any more detail here.

If the magnetization of the magnetic core is asymmetrical after the switching-on of the electric device, the compensating device symmetrizes the magnetization of the magnetic core within a short time and therefore brings the electric device into a normal operating state. The auxiliary inductor therefore only has to be used briefly or only needs to be thermally configured for short time duty. This advantageously reduces the size and the costs of the auxiliary inductor.

In a further embodiment of the circuit arrangement according to the invention, an inductance of the auxiliary inductor is variable. For example, the circuit arrangement in this case contains a control unit which is configured for varying the inductance of the auxiliary inductor as a function of a current flowing in the at least one winding.

This makes it possible in particular to reduce the inductance of the auxiliary inductor successively after the switching-on of the electric device, so that the at least one winding of the electric device creates by far the largest voltage drop.

In a further embodiment of the circuit arrangement according to the invention, the auxiliary inductor is connected between a first switch and the electric device.

By means of the first switch, the electric device can be switched on via the auxiliary inductor. Furthermore, the current path having the auxiliary inductor and the electric device can be interrupted by means of the first switch.

A further embodiment of the circuit arrangement according to the invention contains a second switch which is connected to the electric device and which is connected parallel to a current branch having the auxiliary inductor.

It is possible to bridge the auxiliary inductor by means of the second switch. This is reasonable in particular after the magnetization of the magnetic core has been symmetrized by the compensating device and the system has stabilized, so current limitation by means of the auxiliary inductor is no longer required.

In a further embodiment of the circuit arrangement according to the invention, the electric device is a transformer. The auxiliary inductor is then connected to a primary winding of the transformer.

As already explained above, the invention can particularly advantageously be applied to transformers, since high inrush currents and asymmetrical magnetization of magnetic cores can occur in transformers, which are caused by direct current components of currents flowing in the windings of the transformers.

The method according to the invention is used for operating a circuit arrangement which contains an electric device having a magnetizable magnetic core and at least one winding which is configured for generating a magnetic flux in the magnetic core, an auxiliary inductor which is electrically connected to the winding of the electric device, and a compensating device which is configured for suppressing a DC magnetic flux component in the magnetic core. In the method, during switching-on of the electric device, an inrush current of the electric device is conducted through the auxiliary inductor and after the switching-on of the electric device, a DC magnetic flux component in the magnetic core is suppressed using the compensating device.

If the magnetic core is saturated in the case of an asymmetrical magnetization, for example after the switching-on of the electric device, the inductance of the electric device is low. The magnetization of the magnetic core is symmetrized by means of the compensating device, as a result of which the inductance of the electric device adopts its large setpoint again and the large part of the voltage in the circuit arrangement drops across the at least one winding of the electric device.

In the method according to the invention also, the electric device is for example a transformer.

One embodiment of the method according to the invention relates to a circuit arrangement, the auxiliary inductor of which has a variable inductance. In this embodiment of the method according to the invention, the inductance of the auxiliary inductor is varied as a function of a current flowing in the at least one winding.

A further embodiment of the method according to the invention relates to a circuit arrangement having a second switch which is connected to the electric device and parallel to a current branch having the auxiliary inductor. In this embodiment of the method according to the invention, the second switch is closed if the DC magnetic flux component in the magnetic core falls below a specified threshold value.

The features of the method according to the invention correspond to features of a circuit arrangement according to the invention. Therefore, the advantages of the method according to the invention also correspond to advantages of a corresponding circuit arrangement which have already been mentioned above.

Other features which are considered as characteristic for the invention are set forth in the appended claims.

Although the invention is illustrated and described herein as embodied in a circuit arrangement having an electric device with a magnetizable magnetic core, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a circuit diagram of an exemplary embodiment of a circuit arrangement according to the invention; and

FIG. 2 is a flowchart of an exemplary embodiment of the method according to the invention.

### DETAILED DESCRIPTION OF THE INVENTION

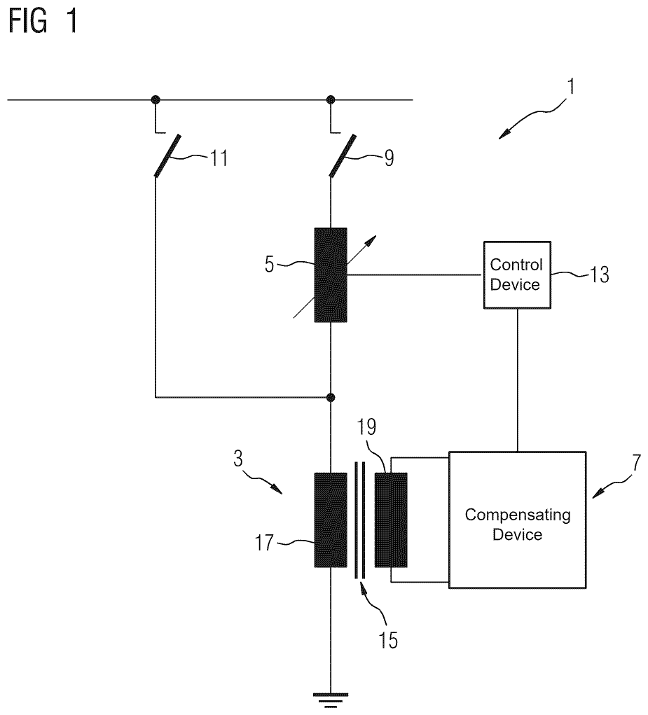

Referring now to the figures of the drawings in detail and first, particularly to FIG. 1 thereof, there is shown a circuit diagram of an exemplary embodiment of a circuit arrangement 1 according to the invention. The circuit arrangement 1 contains an electric device 3, an auxiliary inductor 5, a compensating device 7, a first switch 9, a second switch 11, and a control device 13.

The electric device 3 is a transformer for example and has a magnetizable magnetic core 15 and a winding 17 which, if the electric device 3 is a transformer, is a primary winding of the transformer.

The auxiliary inductor 5 is connected between the first switch 9 and the electric device 3. The auxiliary inductor 5 has a variable inductance. For example, the inductance of the auxiliary inductor 5 is variable between the value zero and a maximum inductance. The maximum inductance is dimensioned such that, in the case of the maximum inductance, the auxiliary inductor 5 limits an inrush current of the electric device 3 to a specified maximum value even if the magnetic core 15 of the electric device 3 is completely saturated.

The compensating device 7 is configured for suppressing a DC magnetic flux component in the magnetic core 15. For this purpose, the compensating device 7 has a compensating winding 19 for generating a magnetic flux in the magnetic core 3, the effect of which opposes a DC flux component. The compensating device 7 is configured in detail like a device described in European patent applications EP 3 783 630 A1 or EP 3 786 987 A1 and is therefore not described in any more detail here.

By means of the first switch 9, the electric device 3 can be switched on via the auxiliary inductor 5. Furthermore, the current path having the auxiliary inductor 5 and the electric device 3 can be interrupted by means of the first switch 9.

The second switch 11 is connected to the electric device 3 and parallel to a current branch having the auxiliary inductor 5 and the first switch 9. It is possible to bridge the auxiliary inductor 5 by means of the second switch 11.

The control unit 13 is configured for varying the inductance of the auxiliary inductor 5 as a function of a current flowing in the winding 15. The current flowing in the winding 15 is detected for example by a current measuring unit of the compensating device 7 and supplied to the control unit 13.

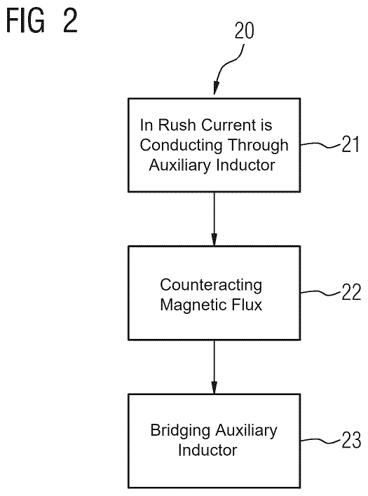

FIG. 2 is a flowchart 20 of an exemplary embodiment of the method according to the invention having method steps 21, 22, 23 for operating a circuit arrangement 1 that is described with reference to FIG. 1.

In a first method step 21, during switching-on of the electric device 3, the first switch 9 is closed and the second switch 11 is opened, so that an inrush current of the electric device 3 is conducted through the auxiliary inductor 5 and limited by the auxiliary inductor 5.

In a second method step 22, after the switching-on of the electric device 3, a DC magnetic flux component in the magnetic core 15 is counteracted using the compensating device 7. At the same time, the inductance of the auxiliary inductor 5 is reduced with falling current flowing in the winding 17 of the electric device 3.

In a third method step 23, after the magnetization of the magnetic core 15 has been symmetrized by the compensating device 7 and the system has stabilized, the second switch 11 is closed and thus the auxiliary inductor 5 is bridged. At the same time, the first switch 9 can be opened.

Although the invention has been illustrated and described in more detail by preferred exemplary embodiments, the invention is not restricted by the disclosed examples and other variations may be derived therefrom by a person skilled in the art without departing from the scope of protection of the invention.

1. A circuit configuration, comprising:
an electric device having a magnetizable magnetic core and at least one winding configured for generating a magnetic flux in said magnetizable magnetic core; and
an auxiliary inductor electrically connected to said at least one winding of said electric device and configured for limiting an inrush current during switching-on of said electric device.

2. The circuit configuration according to claim 1, further comprising a compensating device configured for suppressing a DC magnetic flux component in said magnetizable magnetic core.

3. The circuit configuration according to claim 1, wherein an inductance of said auxiliary inductor is variable.

4. The circuit configuration according to claim 3, further comprising a controller configured for varying the inductance of said auxiliary inductor in dependence on a current flowing in said at least one winding.

5. The circuit configuration according to claim 1, further comprising a first switch, said auxiliary inductor is connected between said first switch and said electric device.

6. The circuit configuration according to claim 1, further comprising a second switch connected to said electric device and connected parallel to a current branch having said auxiliary inductor.

7. The circuit configuration according to claim 1, wherein said electric device is a transformer.

8. A method for operating a circuit configuration having an electric device with a magnetizable magnetic core and at least one winding configured for generating a magnetic flux in the magnetizable magnetic core, an auxiliary inductor electrically connected to the at least one winding of the electric device, and a compensating device configured for suppressing a DC magnetic flux component in the magnetizable magnetic core, which comprises the steps of:
conducting an inrush current of the electric device through the auxiliary inductor during a switching-on of the electric device; and
suppressing a DC magnetic flux component in the magnetizable magnetic core using the compensating device after the switching-on of the electric device.

9. The method according to claim 8, wherein an inductance of the auxiliary inductor is variable and is varied in dependence on a current flowing in the at least one winding.

10. The method according to claim 8, wherein a second switch, which is connected to the electric device, is connected parallel to a current branch having the auxiliary inductor and is closed if the DC magnetic flux component in the magnetizable magnetic core falls below a specified threshold value.
